(19) United States
(12) Patent Application Publication
(10) Pub. No.: US 2007/0012820 A1
(43) Pub. Date: Jan. 18, 2007

(54) Reusable upper stage

(76) Inventor: David Buehler, Provo, UT (US)

Correspondence Address: DAVID BUEHLER, 893 W 2150 N, PROVO, UT, 84604, US

(21) Appl. No.: 11/202,896

(22) Filed: Aug. 11, 2005

Related U.S. Application Data
(60) Provisional application No. 60/600,568, filed on Aug. 11, 2004.

(51) Int. Cl. B64G 1/00

(52) U.S. Cl. 244/158.9

(57) ABSTRACT

This patent describes a reusable upper-stage, that utilizes a position-adjustable propulsion module and payload compartment, an aeroshell, a guidance and control system, and a deployable landing apparatus. The position-adjustable upper-stage propulsion module is shifted forward in the aeroshell prior to reentry into the atmosphere to allow the stage to reenter in a stable, nose-first orientation. It is shifted back to allow the stage to fall tail first and use its engine to do a final deceleration and a powered soft landing, supported by deployable landing apparatus.

This application claims the benefit of provisional application 60/600,568 filed Aug. 11, 2004 entitled “Reusable Upper Stage”.

It also references USPTO disclosure document number 548532 filed Mar. 9, 2004, entitled “Reusable Upper Stage”.

### BACKGROUND OF THE INVENTION

1. Field of the Invention

The present invention is related to aerospace vehicles and transport systems and, more particularly, to Earth-to-orbit aerospace vehicles used for the deployment of payloads, such as satellites, into low Earth orbits.

2. Description of Related Art

It is widely held in the Earth-to-orbit launch community that one of the single biggest keys to reducing the currently high costs of launching anything into orbit is by making the launch vehicle hardware fully reusable. This stems from the generally high cost of launch vehicle systems. Most current expendable launch vehicles cost tens of millions of dollars to build only to be tossed away after each launch. If that hardware could be recovered and reused at a low enough cost, the hardware cost per launch can be significantly reduced. Being able to reuse the hardware in many cases also provides higher reliability. Each flight vehicle could be tested and debugged before going into commercial operations much like the current practice with commercial and military aircraft.

Several prior art systems have been patents. For example:

U.S. Pat. No. 6,557,803 discloses a crewed on-orbit, returnable, and reusable space vehicle.

U.S. Pat. No. 5,927,653 discloses a two-stage reusable earth-to-orbit aerospace vehicle and transport system that employs a airbags and parachutes for reentry and landing.

U.S. Pat. No. 6,068,211 discloses a method of earth orbit space transportation and return. A reusable space craft is deployed from air and jettisoned into orbit. Upon return, the space craft flies and lands with airplane-like functionality and utility.

U.S. Pat. No. 6,557,803 discloses a crewed on-orbit, returnable, and reusable space vehicle that uses multiple reusable boosters and an airplane-like return landing.

U.S. Pat. No. 6,264,144 discloses a material assembly for an inflatable aerodynamic braking device for spacecraft deceleration and the like. Includes inflatable materials that withstand extreme temperatures.

U.S. Pat. No. 5,842,665 discloses a launch vehicle with engine mounted on a rotor that enables it to launch to orbit and return to a destination point.

However, in spite of the desirability of being able to fully reuse the launch vehicle, and in spite of the many concepts that have been proposed, to this date no fully reusable Earth-to-orbit launch vehicle has flown. In fact, there is only one currently operating example of a reusable launch vehicle, the Space Shuttle, and it in fact is only partially reusable requiring extensive refurbishment, check-out, and inspection between each launch. Of the various proposed solutions, almost all of them suffer from various drawbacks and disadvantages.

For example, one of the most commonly proposed methods for making a space vehicle reusable is to give it wings to allow for horizontal landing. The drawbacks to these options is that they generally are very volume inefficient, the wings are often massive, and there are often severe strains put on the thermal protection systems of the vehicles. While this may work fine for a suborbital vehicle, these problems can become quite severe for an orbital vehicle. When the complicated aerodynamic steering and landing equipment such as flaps and landing gear is added, the result is a fairly expensive and complicated system. To make matters worse, most rockets are vertically launched. Putting a body that can generate aerodynamic lift at the end of a long rocket causes significant steering issues for the rocket. If it is horizontally launched, it either requires a very large flying carrier vehicle, or it requires very heavy wings and landing gear to be able to handle that much weight on takeoff.

Another option frequently proposed is a capsule-style ballistic system using a parachute for landing. These also have problems. One is that parachute recovery usually requires the craft to be recovered at sea which has usually been done in the past with an aircraft carrier, which are very expensive to operate. There can also be problems with actually reusing the vehicle due to seawater corrosion. Some capsules like those used by Russia and China are recovered on land, but this requires braking rockets and such vehicles are relatively limited as to where they may land. One difficulty with a parachute descent is that it offers very little precision in the system's landing location. Parachutes also have very limited cross-range capability. There is also the risk that the retrorockets might not fire correctly or that there might be substantial impact damage if using airbags for final landing.

Several suggestions for making Single Stage to Orbit (SSTO) reusable launch vehicles have also been proposed. However, these suffer from the fact that their entire weight must be put into orbit and brought back down again. This greatly reduces there potential payload and makes them much less economically feasible even if they prove to be technically possible.

Two-Stage to Orbit (TSTO) RLVs are significantly easier to develop. For most TSTO designs, the upper stage is usually the more expensive and complicated in spite of being physically much smaller than the lower stage. However, while the prospect of reusing the upper stage is attractive financially, it is also complex to develop and test.

What is needed is a simple that can function as the top stage of a TSTO system that can safely perform a soft landing and be prepared for re-use at a minimal cost in a minimal amount of time. Its use should also avoid added complexity of the lower stage design (being a standard rocket) and avoid the complexity and cost of wings or lifting-bodies on the upper stage. It should be a minimally more complex than a non-reusable upper stage, and should be capable of a precisely located soft landing on Earth to minimize operational costs of the system by allowing it to land at the launch site.

### SUMMARY OF THE INVENTION

The present invention consists of an upper stage which has the capability of making precision landings, is completely reusable, and requires a minimal amount of time for check-out, inspection, and overhaul between flights. The main embodiment consists of an upper stage that uses room temperature propellants and consists of a propulsion system, an aeroshell that protects the stage from undue heating on launch and upon reentry, a guidance system with power source, extendable legs for landing, and a system to allow the propulsion module to be shifted forward and backward during reentry. The upper stage uses its main engine for a powered precision vertical landing.

The vehicle is designed to reenter nose-first in a ballistic manner. The aeroshell is covered by a transpiration or ablative thermal protection system for the reentry. The vehicle has an internal actuation system that allows the center of gravity of the stage to be varied during the reentry process thus allowing for the transition from a nose-first reentry to a side first semi-ballistic phase (which allows for greater cross-range movement than a purely ballistic reentry), and finally to a tail-first attitude for landing. The vehicle can be kept fairly stable throughout the entire reentry process.

In one embodiment, the landing gear is a system of light-weight, inflatable, heat-resistant legs. These are lighter than metal landing gear and allow the legs to be stowed in a much smaller space than typical folding metal landing gear.

In operation, the system works as follows: The upper stage is launched as the second stage of the two stage launch system. The payload compartment is mounted on the top of the propulsion module. After the upper stage separates from the lower stage, its engines are ignited and burn sufficiently to reach the desired orbit. The propulsion module is then slid back until the payload is uncovered. The payload is released, and the propulsion module is moved forward to a position inside the aeroshell (which remains in one piece).

At the proper time, the upper stage performs a de-orbit burn to decelerate enough to drop out of orbit and back into the atmosphere. At this point, the propulsion module slides forward within the aeroshell so the center of gravity is positioned forward. During re-entry and atmospheric descent, the propulsion module can be moved forward and backward to adjust the center of gravity to control the angle of attack and the amount of drag and lift it is generating.

In one embodiment, the spacecraft has fins to control its roll which allows the spacecraft to maneuver backward and forward in order to gain more cross range capability. Cross range capability is useful because it can allow the spacecraft to re-enter from various orbits which may not cross precisely over the landing site.

After the spacecraft has slowed to below Mach 1 and is approaching the landing site, it performs a flip-over maneuver in order to be traveling tail first. This is accomplished by moving the propulsion module backward for another center-of-gravity shift thus putting the spacecraft into a high angle of attack which further reduces the speed. When the spacecraft has descended to a relatively low altitude and is moving at subsonic velocity, the propulsion module is shifted further back until the center of gravity is at the back of the vehicle so it begins to fall tail first.

Just prior to landing the main engines are ignited to reduce the vehicle's velocity from terminal velocity to a safe landing speed prior to touchdown. Thrusters may also be used to maneuver to a precise landing point.

Just before touchdown the landing gear is deployed. If the spacecraft is using inflatable landing gear, it is inflated with a gas stored on the spacecraft at this time. If it is using a mechanical landing gear, it is extended at this time.

Propulsion modules built for the upper stage are made to operate optimally in vacuum. The atmospheric pressures on a propulsion module make the thrust direction unstable under normal atmospheric conditions with a standard nozzle. The nozzle must switch from a nozzle designed for a vacuum environment to one for operation near the Earth's surface in dense atmosphere. Various methods can be employed to accomplish this. In one embodiment, a circular gas injector is attached to the propulsion nozzle to force an even separation of the gas from the nozzle wall at a point where the jet pressure is nearly equal to sea-level ambient pressure. In another embodiment, a dual bell nozzle is used, which contains an inflection point that forces even separation at near sea-level ambient pressures. Both of these embodiments prevent the flow from reattaching to the chamber wall and thus producing large unwanted side-loads on the nozzle. In another embodiment, the lower section of the nozzle is jettisoned to reduce the expansion ration of the nozzle.

One embodiment detailed in this patent can also be used for lunar and planetary landings. For operation as a lander on the moon and planets with little or no atmosphere, the aeroshell is discarded upon exiting the earth's atmosphere. The propulsion module uses thrust to orient the stage for a tail-first landing first. The inflatable landing gear is inflated before landing, as is done for earth landings.

Also, this upper stage can be configured to operate as a free-flyer orbital laboratory or manufacturing facility. In this configuration it is configured with a laboratory or manufacturing module mounted in place of the payload. The upper stage would be sent to orbit as per usual operations, and then the system would stay in orbit until the experimentation or material processing was complete, at which point it would reenter, decelerate, flip to tail first orientation, deploy landing apparatus and land.

This system of the current invention has many advantages over other proposed and existing reusable systems. The semi-ballistic trajectory allows for a degree of cross-range maneuvering during reentry. Using the propulsion module in a powered vertical landing provides much higher landing precision than is typical. This concept also delivers significant operational savings by not requiring the recovery of a stage from the sea or needing to search for a stage after it has landed. Also, by avoiding corrosive sea water, it will be easier to prepare the vehicle for its next flight in a rapid manner. Most importantly, the system is simple and much less expensive than other options. It involves a minor amount of additional hardware over that found on a typical upper stage.

### SHORT DESCRIPTION OF DRAWINGS

FIG. 1 is a pictorial illustration of a payload launch sequence of the two stage rocket.

FIG. 2a is a cross-sectional schematic of the reusable upper stage. FIG. 2b is a cross-sectional schematic of an extended aeroshell.

FIG. 2c is a cross-sectional schematic of the configuration of the upper stage immediately prior to and during reentry.

FIG. 2d is a cross-sectional schematic showing an another embodiment of the upper stage that includes payload doors.

FIG. 2d is a cross-sectional schematic showing an another embodiment of the upper stage that includes payload doors.

FIG. 2f is a cross-sectional schematic showing the reentry configuration of payload door embodiment immediately prior to and during reentry.

FIG. 3 is a pictorial illustration of an upper stage landing sequence.

FIG. 3a. is an illustration of the upper stage, immediately after having released its payload into orbit.

FIG. 3b. is an illustration of the reentry configuration of the reusable upper stage.

FIG. 3c is an illustration of the upper stage during reentry.

FIG. 3d is an illustration of the configuration of the after it has decelerated to supersonic speeds.

FIG. 3e is an illustration of the subsonic configuration of the upper stage. FIG. 3f is an illustration of the vehicle immediately prior to touchdown.

FIG. 4a is a cross-sectional schematic showing the upper stage propulsion unit nozzle with side injection ports.

FIG. 4b is a cross-sectional schematic of another embodiment of the altitude compensation system using a dual bell nozzle.

FIG. 4c is a cross-sectional schematic of another embodiment of the altitude compensation system using a drop-away lower nozzle.

FIG. 5 is a schematic drawing of the inflatable landing legs of the present invention.

FIG. 5a shows the location of the inflatable legs before deployment. FIG. 5b shows the inflatable landing legs deployed.

FIG. 5c is a perspective view of the reusable module on the ground with landing legs deployed.

FIG. 6 shows another embodiment of the inflatable landing cushion using an inflatable toroid.

FIG. 6a An illustration of the upper stage prior to deployment of the toroid. FIG. 6b A cross-section of a deployed toroid.

FIG. 6c A pictorial upper view of the toroid

FIG. 6d A pictorial lower view of the toroid surrounding the nozzle.

### DETAILED DESCRIPTION OF INVENTION

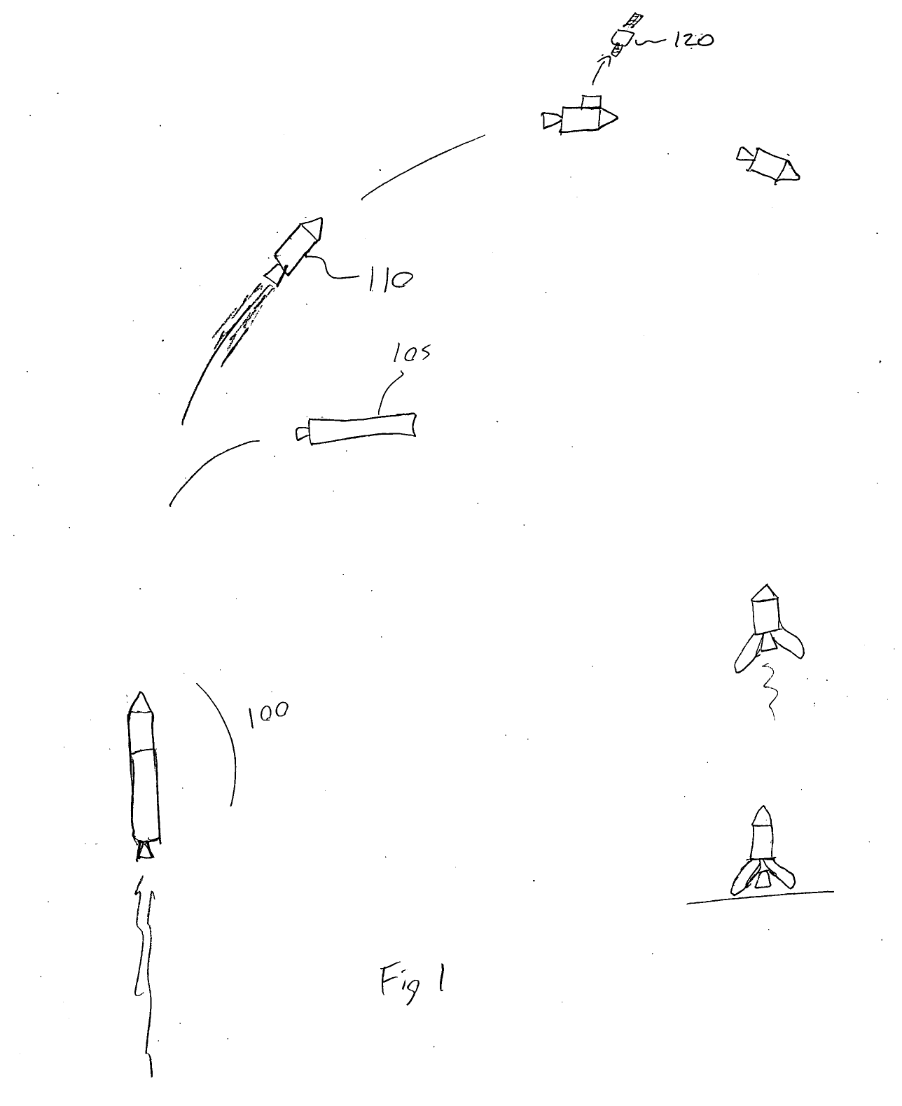

FIG. 1 is a pictorial illustration of a payload launch sequence of the two stage rocket. As depicted, the two stage rocket (100) includes: one or more lower stages (105) releasably connected to an upper stage (110), and a payload (120) that is carried on board the upper stage.

Typically two or more stages are used to send a rocket with payload into space. The rocket shown in this figure uses only two stages, however the unique aspects of this patent can also be applied to a rocket of three or more stages.

In one embodiment, the reusable upper-stage further comprises at least one releasably connected conduit configured allow the stage to be launched with partially filled propellant tanks to allow the main engine to be used to lift the stage away from the lower stage in the event of a malfunction, yet still provide enough acceleration due to the reduced mass of the stage, then allow propellant stored on the lower stage to be transferred to the upper stage prior to upper stage ignition.

In another embodiment, the upper-stage further comprises a liquid payload storage system configured to store liquid payload. In this embodiment, there is a storage system with at least one payload storage tank, a conduit to a load and unload port, and a valve to isolate the load and unload port. This is used to launch liquids such as propellant or water into space economically.

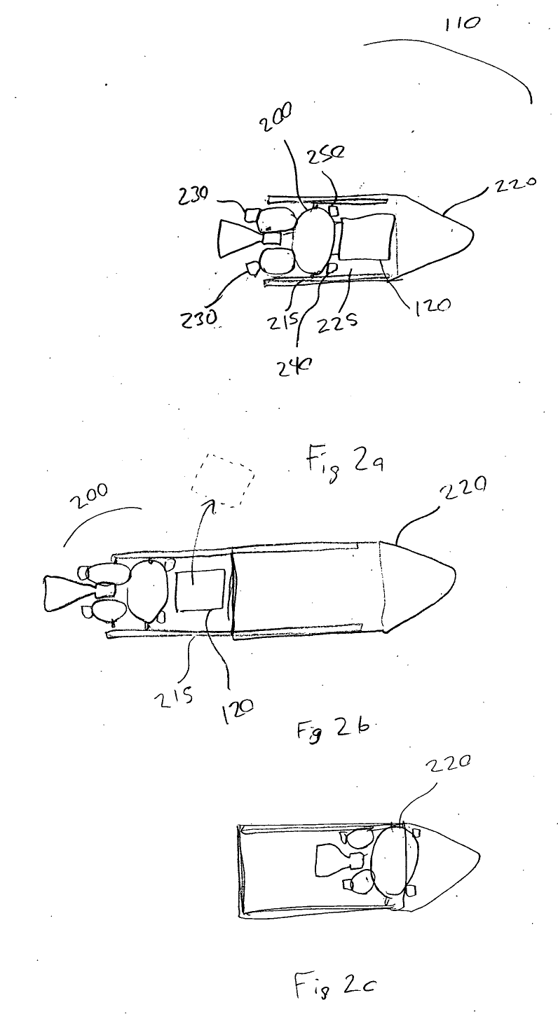

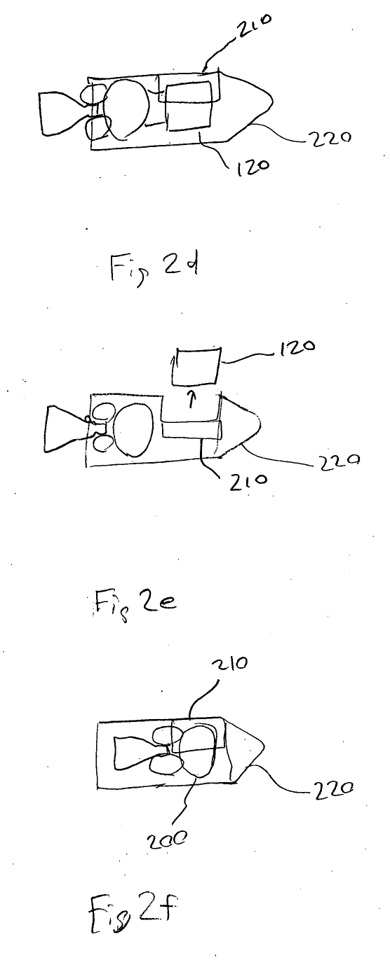

FIG. 2a is a cross-sectional schematic of the reusable upper stage. As depicted, the includes: a propulsion module (200), some retractable railing (215), an aeroshell (220), a payload compartment (225) with a payload (120) inside, an inflatable landing apparatus (230), a guidance and control system (240), and a battery (250).

The propulsion module (200) in one embodiment burns kerosene and peroxide. These room temperature storage propellants do not need to be kept at cryogenic temperatures and can be easily maintained in orbit. They also offer the advantage of being very reliable to ignite in a configuration where the peroxide is decomposed before being mixed with the kerosene.

Because of the aerodynamic loads on the engine nozzle, in the preferred embodiment it does not gimbal but achieves the required thrust vector authority by peroxide side injection in the throat of the nozzle. The nozzle must be sound enough to withstand the aerodynamic loads of the flip maneuver in the atmosphere.

The schematic shows the positioning of the propulsion module (200) with respect to the upper-stage aeroshell (220) in launch position with a payload (120). The propulsion module is able to slide on the railing (215) which allows the stage to shift its center of gravity for different portions of the mission. During launch the propulsion module locked in place.

In another embodiment, a pressurized crew compartment is attached to the inside of the nose of the aeroshell for launching people into orbit and returning them to Earth.

FIG. 2b is a cross-sectional schematic of an extended aeroshell. As depicted, this includes: the extended aeroshell (220), and the payload (120). The aeroshell (220) is in position to release the payload (120).

FIG. 2c is a cross-sectional schematic of the configuration of the upper stage immediately prior to and during reentry. As depicted, this includes the propulsion module (200), and the aeroshell (220).

During and immediately prior to reentry, the aeroshell (220) is fully retracted and the propulsion module (200) adjusted far forward into the aeroshell (230) to change its center of mass. This allows for good nose-first stability on reentry.

FIG. 2d is a cross-sectional schematic showing an another embodiment of the upper stage that includes payload doors. This embodiment includes payload doors (210) to enclose the payload (120) prior to dispensing it.

FIG. 2e is a cross-sectional schematic of the payload door embodiment, showing the payload being released. The payload (120) is being released through the open payload doors (210).

FIG. 2f is a cross-sectional schematic showing the reentry configuration of payload door embodiment immediately prior to and during reentry. Prior to reentry, after the payload (120) has been released, the payload doors (210) are closed, and the propulsion module (200) is shifted forward inside the aeroshell (220) to change the center of gravity for reentry.

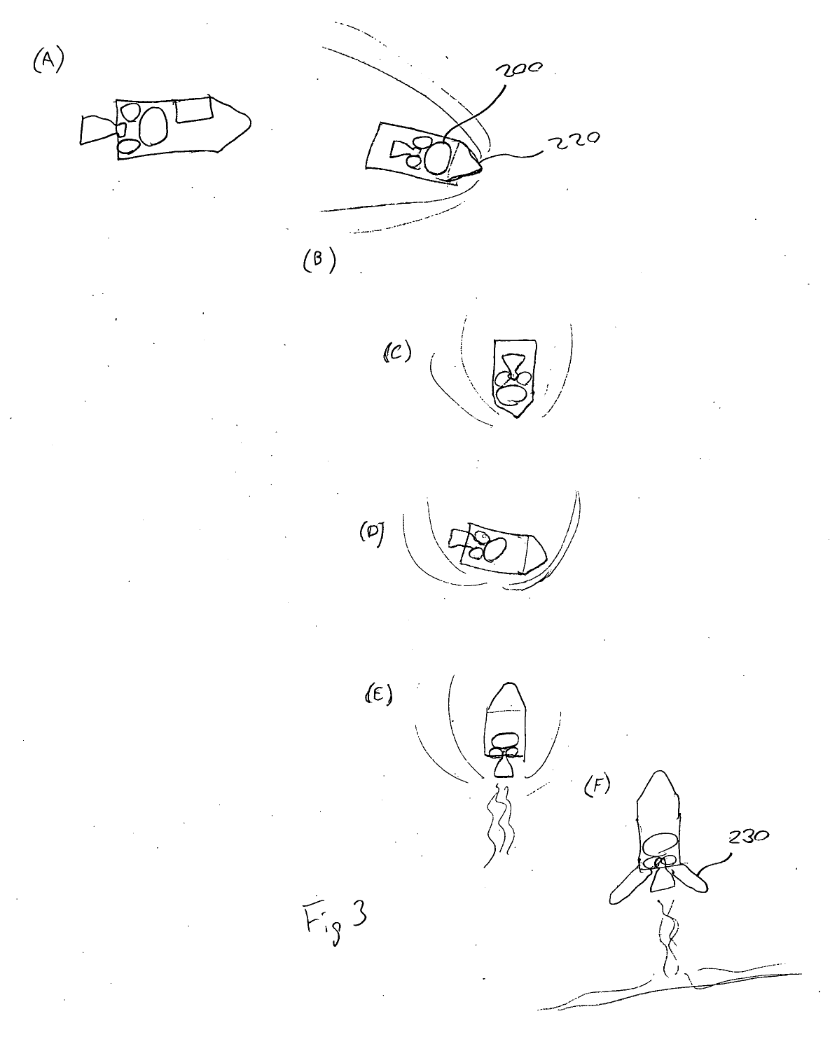

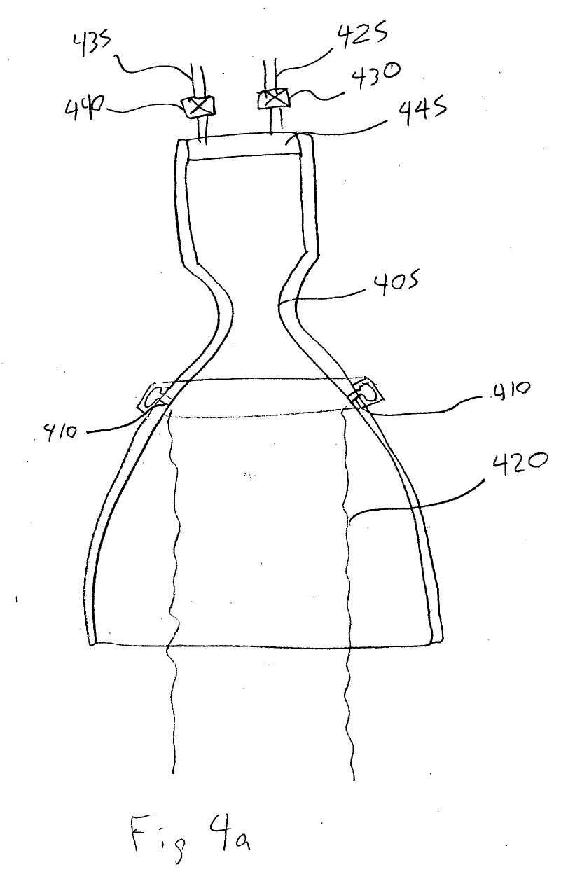

FIG. 3 is a pictorial illustration of an upper stage landing sequence. The landing sequence illustration includes: the propulsion module (200), the aeroshell (220), and the inflatable landing apparatus (230).

FIG. 3a. is an illustration of the upper stage, immediately after having released its payload into orbit.

FIG. 3b. is an illustration of the reentry configuration of the reusable upper stage. For reentry, the propulsion module (200) is moved forward into the nose of the aeroshell (220), to move its center of gravity forward.

FIG. 3c is an illustration of the upper stage during reentry. As in FIG. 3b, the propulsion module (200) is shifted forward inside of the aeroshell. The center of mass is now ahead of the center of pressure causing it to orient itself in the direction of motion through the atmosphere.

FIG. 3d is an illustration of the configuration of the after it has decelerated to supersonic speeds. Here, the propulsion module is shifted to the center of the stage placing the center of mass there. The stage then rotates to fall substantially sideways to present a larger frontal area to the air. This increases the drag on the stage which further slows it. Also, in one embodiment, small aerodynamic surfaces allows the to steer itself, giving it substantial cross range.

FIG. 3e is an illustration of the subsonic configuration of the upper stage. Once the stage has reached an subsonic velocity and a low altitude around 3000 meters, the propulsion module moves back to the aft end of the stage. This urges the stage to an upright position because the drag will move the nose more than the tail causing the stage to pivot with the nose pointing away from earth. The propulsion module engine is ignited which continues to slow the stage to a speed compatible with the deployment of the landing legs (230).

FIG. 3f is an illustration of the vehicle immediately prior to touchdown. The vehicle has slowed sufficiently that the inflatable landing legs (230) can then deployed and inflated before landing. The stage lands on the ground as the inflatable legs (230) support the stage and cushion the impact.

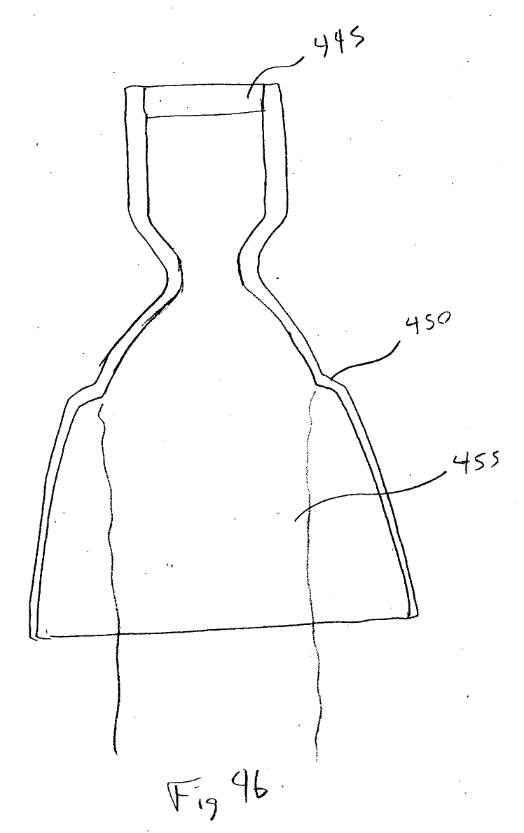

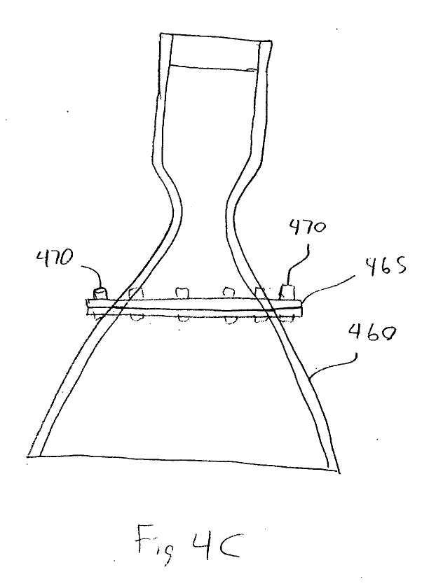

FIG. 4a is an illustration of various ways to compensate for flow separation. Without altitude compensation, flow separation could possibly occur leading to unpredictable thrust vectors and side loads on a nozzle designed for low-pressure or vacuum rather than atmospheric operation.

FIG. 4a is a cross-sectional schematic showing the upper stage propulsion unit nozzle with side injection ports. This propulsion unit includes: a nozzle (405), side injection ports (410), a flow path which the detached flow follows (420), a fuel inlet (425), a fuel valve (430), an oxidizer inlet (435), an oxidizer valve (440), and the injector (445).

In this embodiment, there are below the throat of the nozzle (405) several side injection ports (410) are located. The side injection ports (410) inject a propellant into the main flow at a point near the normal at sea level separation point forcing the main flow to separate from the nozzle (405) at this point thus performing like a smaller area ratio nozzle. The flow then follows path (420). In one embodiment, the propellant injected through he side injection ports is catalytically decomposed hydrogen peroxide.

FIG. 4b is a cross-sectional schematic of another embodiment of the altitude compensation system using a dual bell nozzle. This nozzle includes: the propellant injector (445), an inflection point (450), and the flow path of a gas (455) when the ambient pressure is near sea-level. The inflection point (450) causes the flow to detach at the inflection point and follow path (455), if the engine is operating at low-altitudes. At higher altitudes, the flow would fill the nozzle like a normal high-expansion nozzle.

FIG. 4c is a cross-sectional schematic of another embodiment of the altitude compensation system using a drop-away lower nozzle. This nozzle includes a jettisonable lower section (460), a disconnect flange (465), and a disconnect mechanism (470). This section (460), is attached to the disconnect flange (465) by a disconnect mechanism (470), and is jettisoned prior to reentry to prevent flow separation at lower atmospheric levels. In one embodiment, the disconnect mechanism (470) consists of quick disconnect bolts such as those made by Starsys Corp.

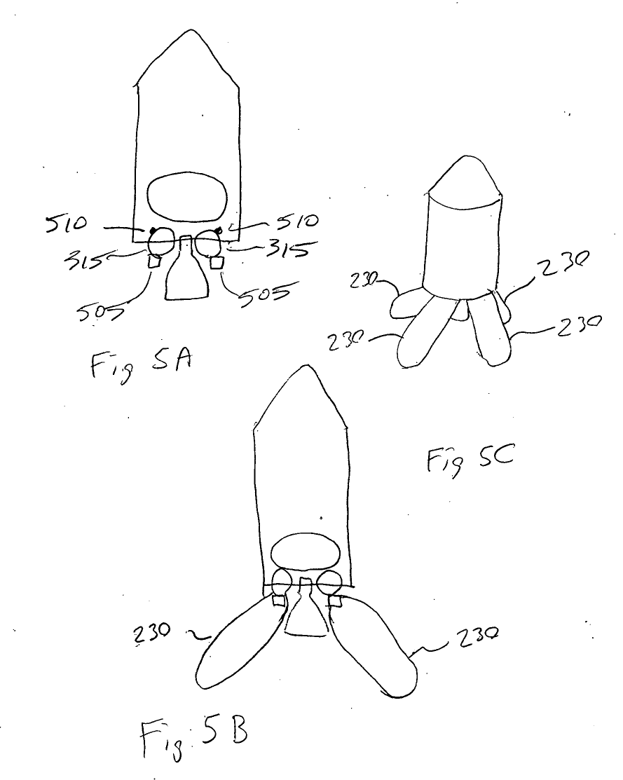

FIG. 5 is a schematic drawing of the inflatable landing legs of the present invention. This schematic includes the (110), the inflatable landing legs (230), the landing leg compartment (505), and landing leg deployment valve (510). The inflatable landing legs are made of a durable, gas-impermeable material that can withstand the scuffs and heat of landing.

FIG. 5a shows the location of the inflatable legs before deployment.

FIG. 5b shows the inflatable landing legs deployed. Upon reaching the desired altitude and decent velocity the compartment (505) is opened, releasing the deflated landing legs, and valve (510) is opened releasing the pressurized gas to inflate the legs (230).

FIG. 5c is a perspective view of the reusable module on the ground with landing legs deployed.

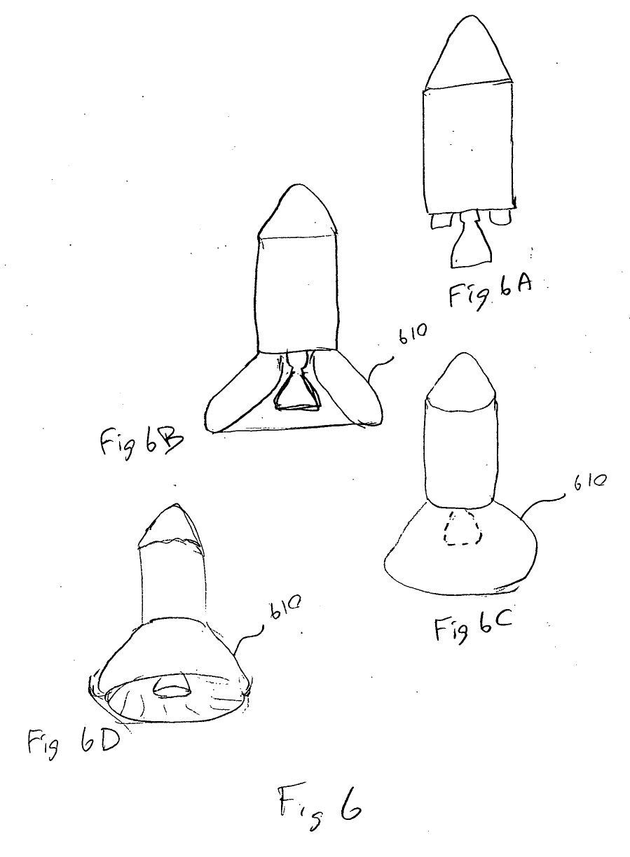

FIG. 6 shows another embodiment of the inflatable landing cushion using an inflatable toroid. This embodiment includes an inflatable toroid (610). This embodiment provides more strength against translational forces whereas the embodiment using inflatable legs provides more cushioning between the stage and the ground.

FIG. 6a An illustration of the upper stage prior to deployment of the toroid.

FIG. 6b A cross-section of a deployed toroid.

FIG. 6c A pictorial upper view of the toroid.

FIG. 6d A pictorial lower view of the toroid surrounding the nozzle. The toroid adds some ground effect deceleration to the vehicle as it lands by capturing the pressure of the exhaust.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

We claim:

1. A reusable upper-stage, comprising:
an aeroshell with thermal protection to protect the upper stage from aerodynamic loads and heating during ascent and reentry;
a position-adjustable upper-stage propulsion module and payload compartment configured to move forward and backward relative to the aeroshell to change the center of mass of the vehicle;
a guidance control system configured to guide and control the upper-stage; deployable landing apparatus configured to support the stage after landing.

2. The reusable upper-stage claimed in claim 1, wherein the propulsion module further comprises at least one bi-propellant liquid main rocket engine configured to provide propulsion to the stage and a fuel and oxidizer storage reservoirs configured to store propellant for the stage.

3. The bi-propellant propulsion module claimed in claim 2, wherein the propulsion module further comprises a pressure-fed propellant delivery system to provide propellant to the at least one bipropellant liquid rocket main engine with propellant already pressured to a pressure in excess of that of the thrust chamber.

4. The propulsion module claimed in claim 1, wherein the propulsion module is further configured to use hydrogen peroxide and a hydrocarbon as propellant.

5. The reusable upper-stage claimed in claim 1, wherein the propulsion module is further comprises a reinforced fixed orientation rocket engine nozzle with liquid side-injection thrust vector control system configured to provide thrust steering with nozzle that can withstand significant aerodynamic side loads during the flip maneuver before landing.

6. The reusable upper-stage claimed in claim 1, wherein the deployable landing apparatus further comprises an inflatable landing gear configured to support the stage after landing and absorb some of the landing impact loads.

7. The inflatable landing gear claimed in claim 7 comprises of a plurality of inflatable pressure enclosures evenly spaced radially around the base of the propulsion module.

8. The reusable upper-stage claimed in claim 1, wherein the upper-stage further comprises a laboratory payload attachment interface configured to mount a recoverable laboratory for experiments and manufacturing in orbit that remains attached to the upper-stage for the entire duration of the mission.

9. The reusable upper-stage claimed in claim 1, wherein the stage further comprises a electrical energy storage system configured to provide electrical power to the spacecraft systems, a system of light to electricity conversion devices configured to provide electrical power from sunlight to the spacecraft and to recharge the electrical energy storage system, a inertial navigation system configured to provide location data and attitude data to the guidance and control system, a flight computer configured to provide data processing capability to the control system, and an attitude control system configured to control the reusable upper stage's attitude while in orbit.

10. The reusable upper-stage claimed in claim 1, wherein the stage further comprises a sliding connection mechanism configured to allow the propulsion module to move forward and aft relative to the aeroshell.

11. The sliding connection mechanism claimed in claim 11, wherein the sliding connection mechanism is further configured to allow the propulsion module to be extended all the way out of the aeroshell to allow a payload to be released behind the aeroshell.

12. The reusable upper-stage claimed in claim 1, wherein the stage further comprises a launch locking mechanism configured to allow the propulsion module to lock in place within the aeroshell during launch and a reentry locking mechanism configured to allow the propulsion module to lock in place forward within the aeroshell during reentry.

13. The aeroshell with thermal protection claimed in claim 1, wherein the thermal protection is of a type selected from group consisting of: a replaceable ablative nose tip combined with a body comprised of high temperature capable material, a transpiration cooled nose combined with a body comprised of high temperature capable material, a transpiration cooled nose combined with a body comprised of high temperature capable material with a backup ablative system built behind the transpiration cooled nose.

14. The transpiration system claimed in claim 31, wherein the system has is configured to transpire during the first 40 seconds of flight subsequent to launch to prevent insect collisions and other potential debris collisions from clogging the transpiration ports.

15. The reusable upper-stage claimed in claim 1, wherein the propulsion module further comprises primary payload attachment mechanism configured to securely attach the payload to the stage and release it once in orbit.

16. The reusable upper-stage claimed in claim 1, wherein the stage further comprises a pressurized crew compartment attached to the top of the propulsion module configured to provide a crew with a breathable atmosphere.

17. The reusable upper-stage claimed in claim 1, wherein the propulsion module further comprises at least one altitude-compensating nozzle configured to allow the engine operation to operate in a stable manner at ambient pressures of the earth's surface and in vacuum utilizing a design selected from: a releasably connected, nozzle extension configured to be released after the stage enters the atmosphere before the engine is restarted for landing, a circular, mono-propellant injector located below the throat of the nozzle configured to inject a propellant into the engine exhaust stream to force wall separation of the exhaust stream in the nozzle at a specific point below the throat.

18. The reusable upper-stage claimed in claim 1, wherein the aeroshell is further comprised of moveable aerodynamic surfaces configured to provide for directional control during flight in the atmosphere.

19. An launch system with an upper-stage that capability of landing on a planetary body with no atmosphere, comprising:
at least one lower stage;
an upper stage with:
(1) a releasable payload fairing;
(2) a guidance control system configured to guide and control the upperstage;
(3) deployable landing apparatus configured to allow the support the upper-stage after touch-down;
(4) a propellant transfer port configured to allow the transfer of propellant onto the upper-stage from another spacecraft while in orbit.

20. A method for reusing an upper stage, comprising:
launching the upper stage on at least one lower stage to provide the upper stage with initial velocity;
using the upper stage engines to accelerate the stage into orbit;
after completing the required mission in orbit using a propulsion system adjusting orbit to drop into the atmosphere;
shifting the center of mass of the stage forward by moving the propulsion module forward within the aeroshell;
decelerating in atmosphere in a nose first orientation to less than 300 meters per second;
shifting the center of mass of the stage backward by moving the propulsion module aft within the aeroshell;
flipping the stage to a rear first orientation;
decelerating using rocket thrust when near the Earth;
deploying a landing apparatus and landing on the Earth.
